(19) United States
(12) Patent Application Publication
(10) Pub. No.: US 2008/0201582 A1
(43) Pub. Date: Aug. 21, 2008

(54) Method for Setting an Electrical Field Device

(75) Inventors: Thomas Jachmann, Wendelstein (DE); Andreas Jurisch, Schwante (DE); Volker Rissland, Marwitz (DE); Uwe Ruckl, Berlin (DE); Stefan Schwabe, Berlin (DE); Stefan Walz, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 11/915,494

(22) PCT Filed: May 26, 2005
(86) PCT No.: PCT/DE2005/000971

§ 371 Date: Nov. 26, 2007

(51) Int. Cl. G06F 1/26

(52) U.S. Cl. 713/300

(57) ABSTRACT

A method for adjusting an electric field device in order to simplify its operation includes the following steps: an electronic control unit of the field device identifies an external data storage module that is connected to the field device; the electronic control unit reads personal data allocated to a user of the data storage module out of the external data storage module; the electronic control unit makes adjustments on the field device based on the personal data that has been read.

Electrical field devices are usually used in automation installations for automatically controlling electrical power-supply and distribution networks or chemical and industrial-processing-engineering processes and industrial production processes. In this context, field devices are usually installed close to the process and perform automation tasks, such as the control of switches and actuators and/or the capture of measured values from the automated process.

Field devices today comprise a large number of widely varying functions which are available to an operator of the field device for configuration and control. For this purpose, the field devices normally have input apparatuses, such as a keypad, and display devices, e.g. a display. The various functions and their settings are presented to the operator in the form of what are known as menus, such as are known from the use of current computer applications. To provide an organized structure in the menu presentation, use is frequently made of sub-menus, usually even on a plurality of levels. Thus, a relatively complex arrangement of the individual functions of the field device in the various menus is obtained. The operator is responsible for selecting and activating the desired functions from the relevant menus and sub-menus and for making settings at the appropriate point.

In addition, the selection of particular safety-related functions normally involves the operator of the field device being asked for a password which authorizes him to use the relevant function.

The invention is based on the object of specifying a comparatively simple method, in terms of unit operation, for setting an electrical field device.

To achieve this object, the invention proposes a method for setting an electrical field device in which an electronic control device in the field device identifies an external data storage module connected to the field device, the electronic control device reads personal data associated with a user of the data storage module from the external data storage module, and the electronic control device makes settings in the field device using the personal data which have been read.

The particular advantage of the inventive method is that the electronic control device makes settings in the field device using personal data which are stored on the external data storage module. This external data storage module can be carried by the operator of the field device and connected to the field device in suitable fashion when desired, so that the electronic control device can access the data storage module. This allows respective specific adjustment of settings for simplifying control of the field device for any operator who has an appropriate external data storage module.

In line with one advantageous development of the inventive method, provision is made for the personal data to contain at least one password digital value, identifying a password, for the use of a password-protected function of the field device, the electronic control device to check the at least one password digital value which has been read using a validity digital value stored in a password memory in the field device, and the electronic control device to enable the password-protected function of the field device for use if the password digital value is identified as valid. This significantly simplifies the password request for the operator. This is because whereas conventional field devices have involved the operator of the field device being asked, when using a password-protected function, to use the input apparatus, such as the field device's keypad, to input the required password, the electronic control device based on the inventive method now accesses the external data storage module itself and checks whether the latter stores the relevant password. It then checks whether the password is valid for performing the relevant function. This is done using a validity digital value which is stored in the electrical field device. In the simplest case, the validity digital value is a reference password. If the password stored in the external data storage module matches the reference password in the field device the use of the password-protected function is enabled for the operator of the field device. However, the check can be performed more safely particularly if the validity digital value is just a value which can be used to check the validity of the password but which itself does not match the password. For this purpose, by way of example, what is known as a hash function can be used which, when applied to the password, gives the validity digital value. On the other hand, however, it is also not possible to infer the password from the validity digital value, since a hash function is a one-way function (in the simplest case a checksum formation) so to speak. Thus, the validity digital value is protected against alien intrusions in the field device. Time-consuming, complex input of the password using the keypad is therefore dispensed with, as is the effort of having to remember one or more passwords for the respective password-protected functions.

Alternatively, however, provision may also be made for the personal data to contain authorization data for the use of a password-protected function of the field device, the electronic control device to use the authorization data to check authorization to perform the password-protected function, and the electronic control device to execute the password-protected function only if the authorization data allow performance of the password-protected function. In this case, the external data storage module does not explicitly have to store the respective passwords. From an authorization level which the authorization data contain, the field device can identify whether the operator is authorized to perform the password-protected function.

In this connection, it is also considered advantageous if the electronic control device performs a password-protected function of the field device only after confirmation of a confirmation request produced by the electronic control device. In this way, the field device does not execute the password-protected and hence normally safety-related function fully automatically but rather enquires after the authorization of the operator of the field device. This can be done by pressing a confirmation key on the field device for an appropriate length of time, for example. In this way, control over execution of the relevant password-protected function remains totally with the operator of the field device.

In line with another advantageous embodiment of the inventive method, provision may also be made for the personal data to contain configuration data for setting the electrical field device in respect of setup of control menus and the electronic control device to use the configuration data to set at least one control menu or a control function of the field device. By way of example, such configuration data for setting control menus may be the assignment of particular function calls, often function calls which are used by the relevant operator of the field device or personally favored function calls, to particular function keys of the field device. In such a case the configuration data can be used to produce a menu, for example, which contains a number of most frequently used functions for the operator. When this menu is called, the operator is then able to access the relevant functions quickly and without complication.

Another advantageous embodiment of the inventive method also provides for the personal data to contain work instruction data which specify functions to be executed by an operator on the field device, and for the electronic control device to display the work instruction data in an instruction menu. In order to display to the operator of the field device very easily what work needs to be carried out on the field device, the functions to be executed which are specified by the work instruction data are shown in the instruction menu. One particular advantage in this context is particularly that the work instruction data are compiled and stored on the external data storage module by a third person, for example a commissioning or service engineer, while the work can be carried out by the operator carrying the external data storage module.

In this connection, it is considered advantageous if the work instruction data comprise unit association data, the electronic control device compares the unit association data with a unit identifier for the field device, and the electronic control device displays the work instruction data in the instruction menu only if it identifies the unit association data as matching the unit identifier. This allows a plurality of sets of work instruction data associated with different field devices to be stored on the external data storage module. The respective field device automatically identifies whether the work instruction data are associated with it from the unit association data and the respective unit identifier.

In addition, one advantageous embodiment of the inventive method provides, in this connection, for the electronic control device to produce log data following execution of a function specified by the work instruction data, and for the electronic control device to store the log data on the external data storage module. Thus the log data can be used at any time to check performance of the functions specified by the work instruction data on the field device.

In line with another advantageous embodiment of the inventive method, provision is made that having identified the external data storage module the electronic control device makes the settings in the field device only after producing identification data. This allows misuse of the external data storage module by unauthorized persons to be prevented, since the electronic control device makes the settings in the field device only when appropriate identification data have been input by the operator. Identification data can be produced by inputting a particular code using a keypad, for example, or else by scanning a fingerprint or by means of similar authorization methods, for example.

In order to ensure a necessary level of safety against copying of the personal data or external intrusion, one advantageous embodiment of the inventive method also provides for the personal data to be read from the external data storage module in encrypted form. In this case, the personal data are stored on the external data storage module in encrypted form and are accordingly read in the encrypted form by the electronic control device in the field device.

Another advantageous embodiment of the inventive method also provides for the personal data to be copied from the external data storage module to a buffer store in the electrical field device. This means that the electronic control device does not need to continually access the external data storage module afresh but rather can take the personal data directly from the buffer store in the field device. This speeds up the overall process. In addition, it is not necessary in this case for the external data storage module to be permanently connected to the field device.

In this connection, provision may also be made for the copied personal data to be erased from the buffer store after a prescribed period of time. This means that after the predetermined period of time has elapsed the buffer store is erased and the data in it cannot get into the hands of unauthorized parties.

As an alternative to this, however, provision may also be made for the copied personal data to be erased from the buffer store when the connection between the electronic control device and the external data storage module is interrupted. In this case, the external data storage module is connected to the electrical field device throughout the entire process. The advantage of this is that the operator does not need to perform any further action in order to erase the data from the buffer store; he merely needs to disconnect the external data storage module from the field device again. In this case, the personal data are also present in the electrical field device's buffer store for as long as the operator is working on the field device.

Advantageously, provision may also be made for the external data storage module used to be a USB stick. This is because USB sticks are today widely used and extremely handy external data storage modules.

To explain the inventive method further,

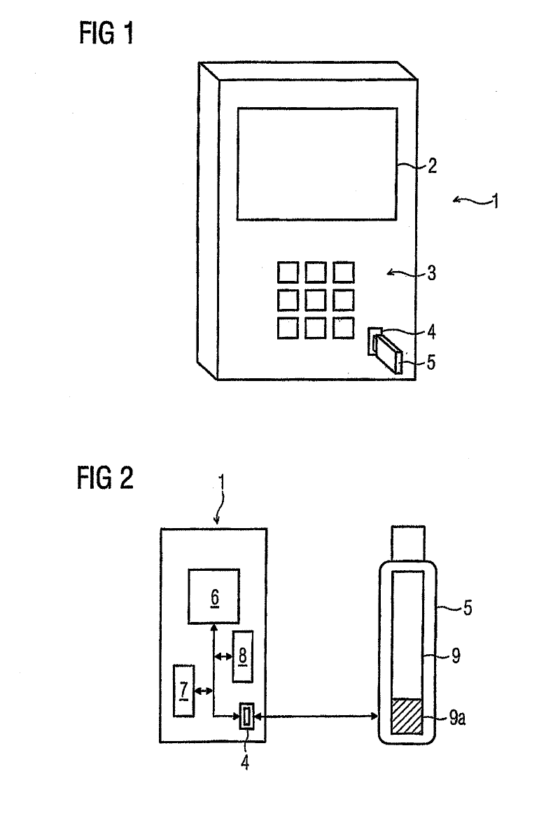

FIG. 1 schematically shows an electrical field device with an external data storage module,

FIG. 2 shows a schematical diagram to explain a method for adjusting an electrical field device,

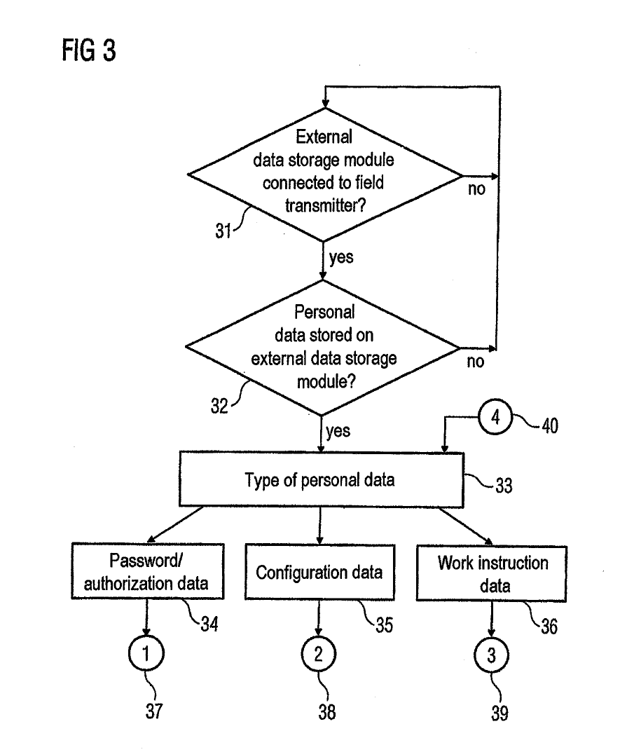

FIG. 3 shows a method flowchart to explain the method for setting a field device,

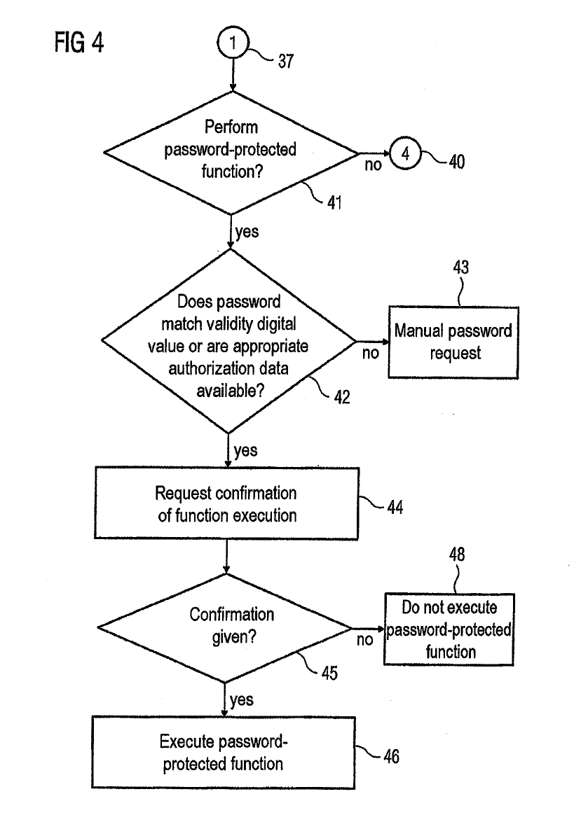

FIG. 4 shows a first method flowchart to continue the method explained in FIG. 3,

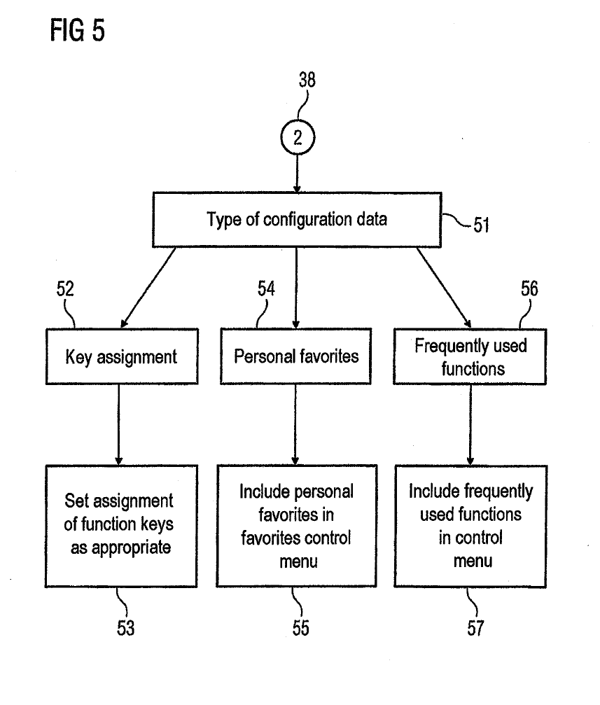

FIG. 5 shows a second method flowchart to continue the method explained in FIG. 3, and

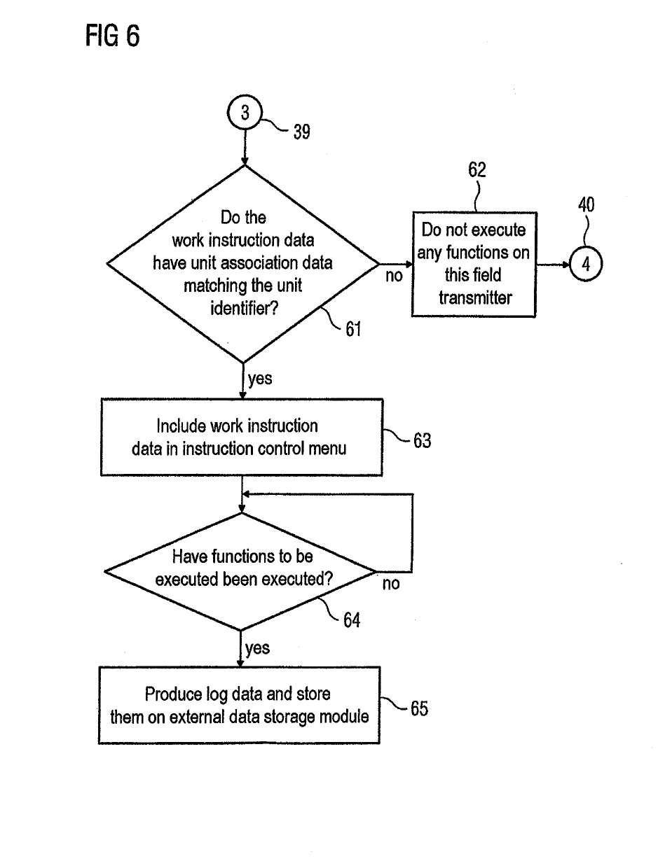

FIG. 6 shows a third method flowchart to continue the method explained in FIG. 3.

FIG. 1 shows an electrical field device 1. Such field devices are usually used in automation installations for automatically controlling power-supply networks, for example. In addition, field devices of this kind can be used in chemical or industrial-processing-engineering installations, industrial production processes or installations for gas and water supply. Usually, the field devices are positioned close to the respective process which is to be automated and have measurement inputs for picking up measured values from the automated process and control outputs for outputting control commands to actuators in the automated process, for example for opening or closing a switch. In addition, field devices may have communication inputs and outputs which they use to interchange data with other field devices, on the one hand, and with control centers in the automation system which are arranged above them in the control hierarchy, on the other hand.

The field device 1 has a display apparatus 2, for example a display, and an input apparatus 3 in the form of a keypad. FIG. 1 does not show an electronic control device controlling the functions of the electrical field device 1. The electronic control device is discussed in connection with FIG. 2.

In addition the electrical field device 1 has a data interface 4 into which an external data storage module 5, which in this case is shown as a USB stick by way of example, has been inserted. However, the external data storage module 5 does not necessarily have to be a USB stick; instead, any options for external data storage modules are possible, such as floppy disks, CD-ROMs, DVD-ROMs, flash memory cards or else external hard disks. In line with the connection options for the external data storage module 5, the data interface 4 of the field device 1 needs to be configured in respectively different form. Instead of a contact-based electrical connection between the data interface 4 and the external data storage module 5, as indicated in FIG. 1 by the inserted USB stick, it is also conceivable to use wireless transmission methods between the external data storage module 5 and a data interface 4 of the field device 1, said data interface being appropriately configured for wireless data transmission, for example using Bluetooth, infrared or radio.

Often, the user of the external data storage module 5 is the operator working on the field device 1. However, it is also possible for the operator to perform the work on behalf of a third person. In this case, the user and the operator can be regarded as different people. In the text below, however, it will be assumed—unless expressly stated otherwise—that the operator and the user are the same person.

An operator of the electrical field device can use the input apparatus 3 to make settings on the electrical field device 1. To this end, the display apparatus 2 usually displays a function menu from which the operator can select appropriate functions using the input apparatus 3. Such function menus are sufficiently well known from the technique of computer applications. Often, a plurality of function menus are provided in a complex menu structure which is distinguished by a plurality of coordinate and subordinate individual function menus. To find a specific function, the operator frequently needs to navigate through a plurality of menu levels in order finally to be able to call the desired function.

Certain safety-related functions, such as the opening or closing of a circuit breaker in a power-supply network via the field device 1 or the setting and changing of particular parameters of the field device 1, are also protected by password request. This means that before the relevant password-protected function is executed the display apparatus 2 is used to display a message to the operator requesting him to input a password. In some cases, different passwords may also be provided for different password-protected functions. In conventional field devices, the operator of the field device uses the input apparatus 2 to input the appropriate password.

The control of a field device is significantly simplified by the method described in connection with FIG. 2. In this regard, FIG. 2 shows the field device 1 in a highly schematic illustration. The field device 1 has an electronic control device 6 which controls the functions of the field device 1. The control device 6 is connected to the data interface 4 of the field device 1. In addition, the electronic control device 6 may be connected to a buffer store 7 and to a password memory 8. However, it is not necessary for the buffer store 7 and the password memory 8 to be accommodated on different physical memory devices, as is indicated in FIG. 2 merely for the sake of clarity. Instead they may also be provided on a common memory device.

The data interface 4 of the field device 1 provides the electronic control device 6 with the opportunity to access the external data storage module 5. The external data storage module 5 has a memory device 9 to which data can be written and from which data can be read. An area 9a (shown shaded in FIG. 2) of the memory device 9 contains personal data which are associated with the user (that is to say normally the operator) of the data storage module 5.

By way of example, the personal data which the memory area 9a contains may be configuration data which the control device 6 in the field device 1 uses to adjust settings for at least one control menu of the electrical field device 1.

By way of example, the configuration data may be what are known as personal favorites. The personal favorites are function calls on the field device 1 which the operator considers important to his work on the field device 1 and therefore selects and has stored in the memory area 9a. When the electronic control device reads these personal favorites from the external data storage module, this allows, by way of example, a favorites control menu of the field device 1 to be adjusted such that it displays these selected function calls. The favorites control menu will then usually be displayed on a directly available menu level, e.g. in what is known as a main menu, by means of the display device 2, so that the operator can select this favorites control menu without further navigation complexity. From the favorites control menu produced in this manner, the operator can then directly select the function calls corresponding to his personal favorites. It is thus not necessary to call the relevant function by navigating through all the necessary sub-menus. This significantly simplifies and speeds up work with the electrical field device.

Another option for personal data stored in the external data storage module 5 is provided by frequently used function calls, for example. Such data are automatically captured by the electrical field device's control device 6, while the operator performs control actions on the field device 1. To this end, the electronic control device 6 keeps statistics, so to speak, regarding what function calls have been called with what frequency. Those function calls which have been called most frequently on the basis of these statistics are stored as personal data on the external data storage module 5. In contrast to the personal favorites, this thus involves automatic selection of the relevant function calls and not manual selection. However, as in the case of the personal favorites, the operator is able to use an appropriate control menu to view and select the most frequently used function calls.

A third option for the personal data is provided by an individual key assignment for specific function keys of the field device 1. This is because if the field device 1 has an input apparatus 3 with specific function keys with which arbitrary function calls can be associated then such association can be made by the personal data stored in the external data storage module 5. By way of example, this allows a function key of the electrical field device 1 to be assigned a function call which prompts transmission of measured values stored in a measured data memory area of the field device 1 (not shown in FIG. 2) to the external data storage module 5.

A common feature of all these personal data is the opportunity for simple setting of the control menus of the electronic field device 1 for the purpose of adjustment to suit the requirements of the respective operator. This is because this allows different operators with respective separate external data storage modules 5, which may respectively store different personal data, to set the control menus such that their ideas are respectively accommodated, since the relevant control menus are respectively set using the personal data which are available on the relevant external data storage module. In this way, different operators of the electrical field device can have different control menus for personal favorites and frequently used function calls and also different assignments for the specific function keys, for example.

Another option for personal data on the external data storage module is passwords stored in the memory area 9a for controlling password-protected functions of the electrical field device 1. This is because instead of the respective manual input of the relevant password by the operator of the electrical field device, the electronic control device 6 can, when a password-protected function of the electrical field device is to be called, first of all check the external data storage module 5 to determine whether it stores an appropriate password. If this is the case then manual password input can be dispensed with and the password request is made without additional control actions solely by the external data storage module 5 which is connected to the field device 1. To this end, the electronic control device 6 reads in a password stored on the external data storage module 5 in the memory area 9a and compares this password with a validity digital value required for the relevant password-protected function in a password memory 8. If the password which has been read matches the validity digital value in the password memory 8 then the electronic control device 6 enables the password-protected function for use by the operator. In the same way, it is also possible for a plurality of passwords which are required for different password-protected functions of the field device to be requested from the external data storage module 5.

Alternatively, it is possible for the memory area 9a of the external data storage module 5 not to contain the relevant password explicitly. Instead, it can store authorization data which the electronic control device can use to check whether the operator who wishes to execute the password-protected function is actually authorized to do so. By way of example, such authorization data can specify an authorization level. The password-protected functions can then in turn have necessary authorization levels associated with them. Before a password-protected function is executed, a check is then performed to determine whether the authorization level stored on the external data storage module 5 is sufficient to allow the specific function to be performed. Thus, by way of example, an authorization level “1” may permit merely the retrieval of measured values and fault logs, while an authorization level “6” allows a circuit breaker to be actuated by the operator.

Provision may be made for the automatic password request or authorization data request from the external data storage module 5 to perform the respective password-protected function automatically. In order to provide the operator with full control over the execution of the password-protected function and to prevent possible errors in the execution, however, the electronic control device 6 should first of all output a confirmation request on the output apparatus 2 (box 45). By way of example, this involves an opening text window in which the operator is asked whether the relevant password-protected function actually needs to be executed. The operator can confirm this on the input apparatus 3 using a confirmation key. By way of example, this can be done by pressing the confirmation key briefly or over a relatively long period of time, for example 3 seconds. Following confirmation by the operator, the electronic control device 6 performs the appropriate password-protected function (box 46), and manual password input is not necessary in this case either. If the confirmation is not forthcoming, however, then the function is not performed, in line with box 48.

To increase safety still further, particularly for the password request by the electronic control device, provision may also be made for the operator to have to produce identification data (e.g. what is known as a PIN) in order to authorize the settings made on the basis of the personal data in the field device 1. By way of example, identification data can be produced by inputting a code or scanning a fingerprint or by means of similar authorization methods. Only if the identification data produced are identified as matching the external data storage module 5 is the field device 1 accordingly set. Producing identification data ensures, in particular, that the person who is in possession of the external data storage module 5 is actually authorized to use it.

Another option for personal data stored in the external data storage module 5 is provided by what are known as work instruction data. Such work instruction data specify functions which are to be executed in the field device 1 by an operator, for example in the form of a checklist.

If the electronic control device 6 finds work instruction data stored in the memory area 9a, it shows them in an instruction menu using the display apparatus 2 of the field device 1. The operator can take the functions to be executed from this instruction menu and can execute them as appropriate.

In this connection, it is appropriate to provide the work instruction data with unit association data. This allows work instruction data intended for a plurality of field devices to be stored on the external data storage module 5. The electrical control device 6 uses the unit association data and a unit identifier for the field device 1 to check whether the work instruction data are associated with the relevant field device 1. If the result of the check is positive then only those work instruction data which are associated with the relevant field device are displayed in the instruction menu.

When the functions to be executed have been performed by the operator, the electronic control device can document the function management with log data which are in turn stored on the external data storage module 5. It is thus possible to check the execution of the individual functions retrospectively. The log data may also be conditioned by an external editing program, for example, so that a clear illustration of the actions performed on the respective field device is produced.

Particularly in the case of the work instruction data explained as personal data, it will frequently arise that the user of the external data storage module 5 and the operator on the field device are not identical. Thus, by way of example, the user of the external data storage module 5 can store the relevant work instruction data on the external data storage module 5. The operator performing the work on the field device 1 on behalf of the user resorts to the work instruction data in this case and has an explicit checklist of activities to be performed on the field device 1. When the operator has performed the work, the user can use the log data to check correct and complete performance.

FIGS. 3 to 6 show the cycles described during a method for setting a field device once again in the form of method flowcharts. They will now be explained briefly.

The start of the method is shown in FIG. 3 by box 31. At this point, the electronic control device 6 in the field device 1 checks whether the field device 1 has an external data storage module 5 connected to it. As already mentioned, this connection can either be wired or wireless. While there is no connection to an external data storage module 5, this step is performed repeatedly. When an external data storage module 5 connected to the field device 1 is identified, the electronic control device checks, in line with the next box 32, whether personal data are stored on the external data storage module 5. If this is not the case then the process loop starts to run from the outset again.

If personal data are found on the external data storage module 5, however, then different functions for setting the electrical field device 1 are performed on the basis of the type of personal data. Box 33 specifies the check on the type of personal data.

As already explained, the personal data may be passwords in line with box 34, configuration data in line with box 35 and work instruction data in line with box 36, for example. The entry markers 37, 38 and 39 which follow these boxes 34, 35 and 36 indicate the appropriate connections to the subsequent FIGS. 4, 5 and 6.

First of all, the function sequence will be considered when the electronic control device 6 finds one or more passwords or authorization data among the personal data. In line with entry marker 37, for this case the link from FIG. 3 to FIG. 4 is produced. In line with box 41, personal data in the form of passwords/authorization data are relevant only when a password-protected function is also to be executed on the electrical field device 1. If this is not the case then, as FIG. 3 shows, the presence of further personal data on the external data storage module 5 is checked. This is indicated by entry point 40, which again refers to FIG. 3. If a password-protected function is to be performed, however, then the electronic control device 6 checks, in line with box 42, whether the password stored on the external data storage module 5 matches the validity digital value stored in the password memory 8 or whether the authorization data permit performance of the function.

If no authorization is found then the operator needs to input the password manually in order to perform the password-protected function. This is indicated by box 43.

If the password matches the validity digital value or if the authorization data indicate adequate authorization then the operator requests confirmation authorizing performance of the password-protected function. As mentioned, the confirmation provided may be the pressing of a specific confirmation key on the field device 1, for example. The confirmation request is indicated in box 44. In line with box 45, the electronic control device 6 checks whether the confirmation has been given by the operator. If this is not the case then execution of the password-protected function is cancelled, as indicated by box 48. By way of example, the electronic control device recognizes that confirmation has not been given from the fact that, by way of example, a cancel key has been pressed or the confirmation has not been given within a prescribed period of time, for example 30 seconds.

When the confirmation has been given by the operator, the electronic control device 6 in the field device 1 executes the password-protected function in line with box 46.

As already explained earlier, provision may also be made for the electronic control device 6 to execute the password-protected function directly after the authorization to perform a function has been found to be positive. In this case, the function steps in boxes 44 and 45 from FIG. 4 would be dispensed with and the check in box 42 would be followed directly by execution of the password-protected function in line with box 46.

FIG. 5 describes the function steps when the personal data are configuration data in line with box 35 in FIG. 3. FIG. 3 and FIG. 5 are in this case linked to one another by means of entry point 38.

First of all, box 51 involves distinguishing what type the configuration data are.

If, in box 52, the configuration data are data for assigning selected function calls to specific function keys the assignment of these specific function keys is set accordingly in box 53.

If the configuration data in box 54 are the personal favorites already explained in more detail then these personal favorites are included in the favorites control menu in box 55 and are provided there for selection. If the configuration data in box 56 are frequently used functions then these frequently used functions are included in an appropriate control menu in box 57. These function steps have already been explained in more detail further above and are therefore not dealt with further at this juncture.

If the personal data in box 36 in FIG. 3 are what are known as work instruction data then entry point 39 in FIG. 3 refers to FIG. 6.

In box 61 in FIG. 6, the electronic control device 6 first of all checks whether the work instruction data have unit association data which match the unit identifier of the electrical field device 1. If this is not the case then the operator does not need to execute any functions on this field device and an appropriate message is displayed by means of the display apparatus 2 of the electrical field device 1. This is indicated in box 62. Finally, entry point 40 starts to run the checking procedure in FIG. 3 again.

However, if appropriate unit association data specify that the operator needs to perform functions for this field device then the work instruction data are included in an appropriate instruction control menu in box 63. In box 64, the control device subsequently checks whether the functions to be executed which are specified by the work instruction data have been executed. As soon as this has happened, what are known as log data are produced in box 65 and are stored on the external data storage module 5. The log data can be used to check the execution of the functions afterwards.

To prevent frequent reading from the external data storage module 5 by the electronic control device 6 in the case of all the described types of personal data, provision may be made, by way of example, for the whole content of the memory area 9a, i.e. all the personal data, to be transmitted to a buffer store 7 in the electrical field device 1 when the operator starts to work on the field device 1. While the electrical field device is being controlled, it is then necessary for the electronic control device 6 to read only the personal data from the buffer store 7 in each case. This speeds up the work operation further. The personal data in the buffer store may be the configuration data described at the outset, work instruction data or else passwords/authorization data for the operator.

In this case, however, it should be ensured that the personal data in the buffer store cannot be accessible to third persons. To this end, by way of example, provision may be made for the buffer store to be automatically erased again when a prescribed period of time has elapsed. If the first operator is still working on the electrical field device 1 after this period of time has elapsed then the relevant personal data would need to be loaded into the buffer store again. Alternatively, provision may be made for the personal data to be erased from the buffer store 7 as soon as the connection between the external data storage module 5 and the electrical field device 1 is broken. This is because in this case it is assumed that the operator is finishing working on the electrical field device 1 and the relevant personal data 7 are no longer needed for the field device 1.

If a further operator then starts to work on the field device 1, the relevant personal data for this further operator can be loaded into the buffer store 7 from the external data storage module 5 of the further operator, while the personal data of the first operator are erased from the buffer store 7. The field device 13 can therefore always be set with the personal data of the respective operator.

To protect the personal data on the external data storage module 5, the personal data should be stored on the external data storage module 5 in encrypted form and should also be read by the electronic control device 6 in the field device 1 in encrypted form. Decryption does not take place until in the field device 1. The personal data can be encrypted using current encryption technologies.

1-14. (canceled)

15. A method of setting an electrical field device, the method which comprises the following steps:
identifying, with an electronic control device in the field device, an external data storage module connected to the field device;
reading, with the electronic control device, personal data associated with a user of the data storage module from the external data storage module; and
making settings in the field device, with the electronic control device, using the personal data read from the external data storage module.

16. The method according to claim 15, wherein:
the personal data contain at least one password digital value, identifying a password, for the use of a password-protected function of the field device;
the electronic control device checks the at least one password digital value using a validity digital value stored in a password memory in the field device; and
the electronic control device enables the password-protected function of the field device for use if the password digital value is identified as valid.

17. The method according to claim 16, which comprises performing the password-protected function of the field device only after confirmation of a confirmation request produced by the electronic control device.

18. The method according to claim 15, wherein:
the personal data contain authorization data for the use of a password-protected function of the field device;
the electronic control device uses the authorization data to check authorization to perform the password-protected function; and
the electronic control device executes the password-protected function only if the authorization data allow performance of the password-protected function.

19. The method according to claim 18, which comprises performing the password-protected function of the field device only after confirmation of a confirmation request produced by the electronic control device.

20. The method according to claim 15, wherein:
the personal data contain configuration data for setting the electrical field device with respect to a setup of control menus; and
the electronic control device uses the configuration data to set at least one control menu or a control function of the field device.

21. The method according to claim 15, wherein:
the personal data contain work instruction data specifying functions to be executed by an operator on the field device; and
the electronic control device displays the work instruction data in an instruction menu.

22. The method according to claim 21, wherein:
the work instruction data comprise unit association data,
the electronic control device compares the unit association data with a unit identifier for the field device; and
the electronic control device displays the work instruction data in the instruction menu only if the unit association data are identified as matching the unit identifier.

23. The method according to claim 21, which comprises:
generating log data with the electronic control device following execution of a function specified by the work instruction data; and
storing the log data on the external data storage module.

24. The method according to claim 15, wherein, after having identified the external data storage module, the electronic control device makes the settings in the field device only after producing identification data.

25. The method according to claim 15, which comprises reading the personal data from the external data storage module in encrypted form.

26. The method according to claim 15, which comprises copying the personal data from the external data storage module to a buffer memory in the electrical field device.

27. The method according to claim 26, which comprises erasing the personal data from the buffer memory after a prescribed period of time.

28. The method according to claim 26, which comprises erasing the personal data from the buffer memory when a connection between the electronic control device and the external data storage module is interrupted.

29. The method according to claim 15, wherein the external data storage module is a USB stick.
